(19) United States
(12) Patent Application Publication
(10) Pub. No.: US 2023/0179701 A1
(43) Pub. Date: Jun. 8, 2023

(54) METHODS AND SYSTEMS FOR RECONSTRUCTING COMMUNICATION SESSIONS USING NATURAL LANGUAGE PROCESSING

(71) Applicant: Avaya Management L.P., Durham, NC (US)

(72) Inventors: Harsh V. Mendiratta, East Brunswick, NJ (US); David Chavez, Broomfield, CO (US)

(21) Appl. No.: 17/545,208

(22) Filed: Dec. 8, 2021

(51) Int. Cl. H04M 3/28; H04M 3/436; H04M 3/08

(52) U.S. Cl. CPC H04M 3/28; H04M 3/436; H04M 3/085; H04M 2203/2066; H04M 2215/8116

(57) ABSTRACT

Methods and systems provided herein ensure that communication sessions such as phone calls over PSTNs can be reconstructed in the event that the session ends unintentionally. Methods and systems include detecting a call ended, analyzing data associated with the call, determining, based on the data, the call ended unintentionally, and reconstructing the call based on the determination the call ended unintentionally.

### FIELD

Embodiments of the present disclosure relate generally to communication methods and specifically to call rebuilding.

### BACKGROUND

Voice calls have been traditionally used to enable users to communicate with others. For example, call centers field voice calls from customers to provide customer service such as technical support and account management. While voice calls allow users to speak in real time and share information without being required to type or otherwise input data, voice calls suffer from many issues, such as the potential for calls to be dropped due to poor communication network connections. Voice calls are also limited in the ability to reconnect after being disconnected. For example, when a voice call is dropped for any issue, such as due to poor coverage or a weak signal, network hiccup, service provider issues etc., or scenarios such as when a user accidently presses the call-end button, the call ends and requires one of the users in the call to redial the other. Such an issue may be minor for two people who know each other's phone number, the issue creates a number of problems in other contexts, such as in call centers. For example, when a person calls into a call center, the person often must spend an amount of time navigating through a system of automated call fielding systems as well as through a network of call center agents. If the call drops for any reason, the person must redial the call center number and renavigate through the system. In addition, when the caller calls back and navigates through the system, the caller is typically connected to a different agent than the agent the caller spoke with in the dropped call. As a result, the caller must repeat the previous discussion and rebuild the context with the new agent.

### BRIEF SUMMARY

As a call traverses from the PSTN into an SIP network, not all the interworking gateways populate SIP message in consistent ways. Often, critical information, such as the reason for a call drop in mobile/PSTN network are omitted or when conveyed, the information is populated in inconsistent manners. When call signaling messages pass through multiple networks with proxies and back-to-back user agent (B2BUA) based servers, the call drop reason is invariably lost. Conventionally, a BYE message as generated by a PSTN does not include a reason as to why the BYE message was generated. Because a BYE message does not include a reason as to why the BYE message was generated, conventional call centers do not have a way to determine based on the BYE message whether the call was dropped intentionally or accidentally. Resultantly, a BYE message received by a SIP based destination/call center has no way to establish whether the call is being dropped because the user hung up, due to a network outage, or as the user accidentally pressed call end button.

It is, therefore, an aspect of the present disclosure to provide a method of reconstructing a call by intercepting a BYE message at a border element and using context aware call rebuilding (CACR) logic to restore the call if necessary. In particular, the present disclosure provides a system capable of intercepting a BYE message generated as a result of a communication session, such as a phone call, ending, determining whether the communication session ended intentionally or unintentionally, and, if unintentionally ended, reconstructing the communication session so that users may continue communicating as if the communication session had not ended.

By providing a border element the functionality of intercepting BYE messages, determining whether the call was ended intentionally, and attempting to reconnect the callers, the systems and methods described herein achieve many benefits over conventional systems. Because, in the event of a dropped or otherwise unintentionally ended phone call, the resulting BYE message is intercepted by the border element, other elements within a call center's network will not receive a BYE message until the call is either intentionally ended or at least until an attempt has been made to reconnect the callers. Because the BYE message is not received by other systems within the call center in such a situation, processes such as call recording or other call monitoring processes may continue until the call is completed.

As used herein, the term “call” should be construed to include any type of electronic communication, whether real-time, near-real-time, or asynchronous. A call may include a voice call, a video call, a web chat, a web conference, a co-browsing session, or the like. A communication session may include one or many calls and the communication session may be between any number of human participants, human and automated participants (e.g., chatbot or interactive voice response (“IVR”) components), and combinations thereof.

As a non-limiting example, the present disclosure may be used to ensure, in the event of a communication session ending unintentionally, that the users participating in the communication session may be enabled to resume the communication session with minimal delay. The problem is twofold. First, when a caller unintentionally ends a call, he or she is participating in with a call center, the caller has no way of quickly resuming the call. Instead, the user must redial the call center number and renavigate through the maze of bots, menus, and human representatives, retelling his or story, trying simply to return to speaking with the same call center agent her or she was speaking with previously. Second, when a call is ended, whether intentionally or unintentionally, a BYE message is generated and propagated.

In the case of a call center, the BYE message may be received by a number of systems and applications, such as a call recording system. Once received, the BYE message may prompt such systems and applications to act based on the call ending. In the event that the call was ended unintentionally, applications such as call recording systems end their processes. This creates an incorrect or incomplete record of the events. Using the systems and methods described herein, the BYE message may not be received by such systems and applications until the call has been intentionally ended.

The present commercial practice is, when a BYE message is received by a SIP-based network, to transmit the BYE message at the point of ingress to the network (e.g., a session border controller (“SBC”), server, etc.) to any systems or processes affected by a call associated with the BYE message, such as a redundant call recording system. This causes such systems or processes to perform end-of-call processes, such as ending a recording, saving data relating to the call, etc.

Presently available solutions do not fully address the problems outlined above (customer-specific or general) and create the issue caused by the transmission of BYE messages even in the event that a call was ended unintentionally. When a BYE message is propagated throughout a system such as a call center following an accidentally ended phone call, the person calling into the call center is not provided an opportunity to quickly resume speaking with the same agent he or she was speaking with during the first call. Instead, the caller must begin again with a new call center agent.

It is therefore an aspect of the present disclosure to provide a communication method and system that enables a communication session to be rebuilt automatically in the event that the communication session is unintentionally ended. This communication method and system can be made by modifying endpoints (e.g., Session Initiation Protocol (“SIP”) User Agents), ingress points (e.g., SBCs, etc.), and/or servers that provide communication features (e.g., a communication server).

In one embodiment, a border element, such as an SBC, may be equipped with context aware call rebuilding (CACR) functionality. When a call is ended, the border element may analyze an audio recording of the call, such as by using natural language understanding (NLU) via an artificial intelligence (AI) element to determine the reason for the call drop. The NLU may be trained to determine whether the call was ended unintentionally, such as due to a poor reception using public switched telephone network (PSTN). For example, the NLU may determine that either party was in the middle of a conversation.

When a call ends, the PSTN may send a call clearing message (e.g., a BYE message) towards the border element and, using a system or method as described herein, rather than propagating the BYE message to other computer systems or processes, e.g., within an internal network with which the border element is associated, the border element can invoke CACR by recalling the parties of the call so that the callers involved in the dropped call may resume their discussion if the NLU determines the call was still actively in progress and thus unintentionally ended. In this way, the call can continue with the original set of applications and with the same contact center agent. When the computing element embedding CACR functionality receives the BYE message from the PSTN, the computing element may first determine whether the call was ended intentionally. If the call was ended unintentionally, the computing element may establish that the received BYE message should not be treated as a call clearing message. The computing element may next acknowledge the BYE message without forwarding the BYE message to the internal network. The computing element may initiate a new call towards the PSTN user, i.e., the caller, for example by sending a new call request, i.e., INVITE, creating a new call leg and patch the new call leg with the internal call leg involved in the unintentionally ended call. This way, the internal call leg is not ended due to an unintentionally ended call and all the applications as well as the agent on the call will not be alerted to the fact that the PSTN user was reconnected by sending a new call request (i.e., INVITE).

By modifying a communication server of a network as provided above, embodiments of the present disclosure provide advantages compared to prior solutions. For instance, the present disclosure enables a network provider or vendor to enable users to resume their discussion following a dropped call, without prompting any type of end-of-call processes, such as ending call recordings or notifying call center agents of a dropped call, and to ensure BYE messages are not unintentionally transmitted throughout a system.

Advantageously, the present disclosure can be implemented as an “over the top,” “cloud” service with no customer network or endpoint prerequisites. Additionally, or alternatively, the proposed solution can be built into endpoints (e.g., telephones, software communication clients, and/or other communication devices) for use on third-party networks (e.g., as a cloud solution). In accordance with at least some embodiments, establishing and continuing a communication session is dependent upon a positive control mechanism instead of upon statistical methodologies (e.g., redundancy).

While the CACR functionality discussed herein is described as being performed by a border element of a call center network, it should be appreciated the CACR functionality may be bundled within or performed by any application in the call path. It should be appreciated the methods and systems described herein should not be limited to being performed by a border element only, but that any computing element in the call path can perform the systems and methods described.

### BRIEF DESCRIPTION OF THE DRAWINGS

FIG. 1 is a block diagram of a communication system in accordance with at least some embodiments of the present disclosure;

FIG. 2 is a block diagram depicting components of a computer system used in a communication system in accordance with at least some embodiments of the present disclosure;

FIG. 3A is a flow diagram depicting a prior art method involving a communication session;

FIGS. 3B and 3C are flow diagrams depicting methods involving communication sessions in accordance with at least some embodiments of the present disclosure; and

FIGS. 4A-4C are illustrations of user interfaces in accordance with one or more embodiments of the present disclosure.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the preceding description omits a number of known structures and devices. This omission is not to be construed as a limitation of the scope of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

It is with respect to the above issues and other problems that the embodiments presented herein were contemplated. It is an object of the present disclosure to provide communication sessions established between parties to be rebuilt based on an analysis of call details such that inadvertently or unintentionally dropped calls may be quickly resumed. In one embodiment, an artificial intelligence system may be trained and configured to determine whether a call was unintentionally ended, and, if so, a border element may attempt to reconnect the call without propagating the BYE message throughout the call center network.

It should be appreciated, when an initial call is made into a call center an external call leg is created between the caller, or PSTN user, and the border element of the call center network. An internal call leg is created between the border element of the call center network and the automated bot or call center agent speaking to the caller. With the initial call is ended for any reason, the call center network will receive a BYE message from the PSTN and the border element, or other computing system or element within the network performing the systems and methods described herein, may respond to the BYE message on the PSTN side without propagating the BYE message throughout the call center network. If the computing system determines the initial call was dropped unintentionally, the computing system may attempt to re-call the caller without propagating the BYE message. If the caller answers the new call from the computing system, a new external call leg is created and patched together with the original internal call leg. Once connected, the new external call leg and the original internal call leg together represent the end-to-end call. When the newly created call ends, and a new BYE message is received from the PSTN, CACR logic may be invoked to determine whether the call was ended intentionally or not. If it is determined, the call was ended intentionally, the received by message will be propagated throughout the call center network.

The terms “call” and “communication session” and/or variations thereof may be used interchangeably herein and may refer to the exchange of voice and/or data communications across one or more communication channels established between different endpoints (e.g., telephones, software communication clients, mobile devices, any other communication device, and/or combinations thereof) in a communication system.

Among other things, the ability to quickly reconnect callers in the event of an unintentionally ended call allows a communication system to provide users a user-friendly experience. Moreover, systems and applications involved with the communication system may be enabled to avoid the performance of unnecessary or unwanted processes. For example, a recording of a call may, using the systems and methods described herein, resume even in the event that the call is dropped, until after the call is reconnected and resumed and intentionally ended by the parties to the call. In some embodiments, the methods and systems described herein may continuously monitor a communication session and, upon determining the communication session unintentionally ended, intercept any BYE message, and attempt to reconnect the callers. In this manner, only calls that are intentionally ended may result in the transmission of a BYE message.

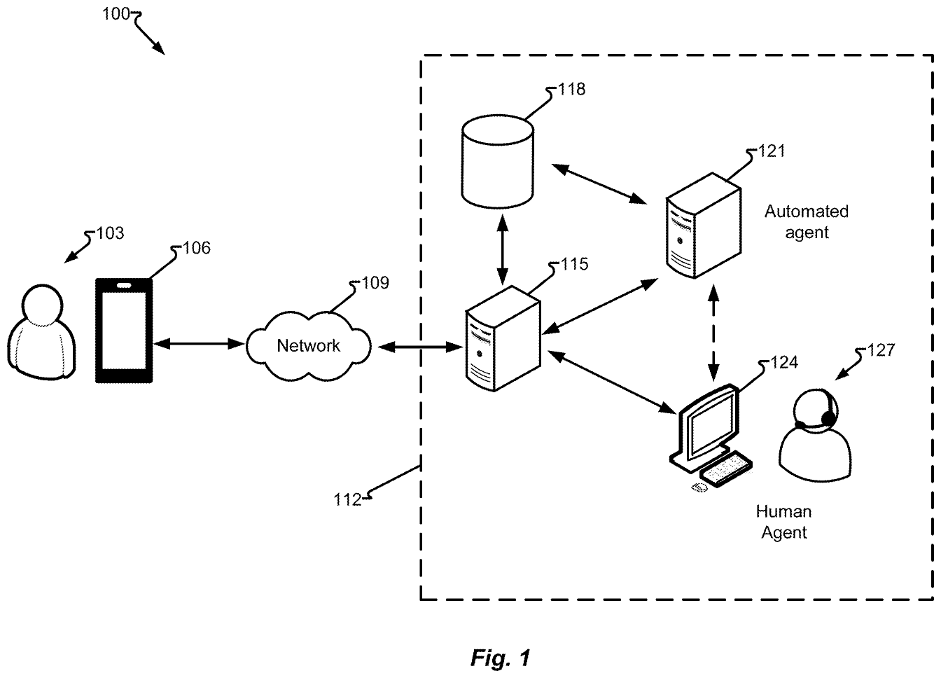

Referring now to FIG. 1, a block diagram of a communication system 100 is shown in accordance with at least some embodiments of the present disclosure. The communication system 100 of FIG. 1 may be a distributed system and, in some embodiments, comprises a communication network 109 connecting one or more communication devices 106 with a communication server 115. The network 109 may be, for example, a public switched telephone network (PSTN) or other type of telephony system. The communication server 115 may be a part of a local or distributed network 112 such as a network of a call center. The communication system 100 may include, but is not limited to, a first communication device 106, communication server 115, and a memory storage device 118. The communication server 115 may provide collaborative communication sessions, conference meetings, multi-party calls, SIP functionality, traditional telephone calls, and/or other audio/video communication services. In some embodiments, the communication server 115 may correspond to an SBC, or other communications controller, through which communications pass as part of a communication session established between two or more communication devices such as a communication device 106 operated by a user 103, a computer system 121 functioning as an automated agent, and a computer system 124 operated by a human agent 127. The communication device 106 may be, for example, a telephone such as a smartphone or other type of device capable of or configured to perform telephone calls via a telephony network such as PSTN.

Although the communication server 115 may control communication sessions between communication devices, it should be appreciated that the functionality of the communication server 115 as described herein may be provided by at least one of the computer systems 121, 124 in the network 112. Stated another way, the computer systems 121, 124 of the network 112 may comprise the various instructions, conditions, rules, and/or data described herein as being performed by the communication server 115. In this manner, the computer systems 121, 124 may communicate with one another across the network 112 as well as with external devices such as communication device 106 via a network 109 such as the PSTN without requiring inclusion of the communication server 115 to provide the conditional requirements and compliance assurances described herein.

It is an aspect of the present disclosure that the users 103, 127 may establish a communication session, such as a phone call. In particular, the each of the users 103, 127 may use a respective communication device 106 or computer system 124 to initiate a call and dial out to another user 103, 127 across the network 109. Upon initiating the call, one or more devices (e.g., computer systems 121, 124, communication server 112, etc.) in the network 112 may perform call-related processes, such as call recording or other types of call monitoring processes. Although only two users 103, 127 and corresponding communication devices 106 and computer systems 124 are illustrated in FIG. 1, it should be appreciated that the communication system 100 may comprise any number of users and communication devices or computer systems capable of communicating via the PSTN or other type of telephony network.

In accordance with at least some embodiments of the present disclosure, the network 109 may comprise any type of known communication medium or collection of communication media and may use any type of protocols to transport messages between endpoints. The communication network 109 may include wired and/or wireless communication technologies. The Internet is an example of the communication network 109 that constitutes an Internet Protocol (“IP”) network consisting of many computers, computing networks, and other communication devices located all over the world, which are connected through many telephone systems and other means. Other examples of the communication network 109 include, without limitation, a standard Plain Old Telephone System (“POTS”), an Integrated Services Digital Network (“ISDN”), the Public Switched Telephone Network (“PSTN”), a Local Area Network (“LAN”), a Wide Area Network (“WAN”), a VoIP network, a SIP network, a cellular network, and any other type of packet-switched or circuit-switched network known in the art. In addition, it can be appreciated that the communication network 109 need not be limited to any one network type, and instead may be comprised of a number of different networks and/or network types. The communication network 109 may comprise a number of different communication media such as coaxial cable, copper cable/wire, fiber-optic cable, antennas for transmitting/receiving wireless messages, and combinations thereof.

In some embodiments, at least one of the communication devices 106 or computer systems 124, 127 may correspond to a computing device, a personal communication device, a portable communication device, a laptop, a smartphone, a tablet, a personal computer, and/or any other communication device capable of running an operating system (“OS”), at least one voice application, communication instructions, and/or the like. The communication devices or computer systems may be configured to operate various versions of Microsoft Corp.'s Windows® and/or Apple Corp.'s Macintosh® operating systems, any of a variety of commercially-available UNIX® such as LINUX or other UNIX-like operating systems, iOS, Android®, etc. These communication devices or computer systems may also have any of a variety of applications, including for example, voice applications, chat applications, calling applications, email applications, SIP applications, etc., and/or combinations thereof. Additionally, or alternatively, the communication devices or computer systems, in some embodiments, may be any other electronic device, such as an Internet-enabled mobile telephone and/or a personal digital assistant, capable of communicating via the communication network 109.

In some embodiments, communications may be sent and/or received via a respective communication device or computer system as a telephone call, a packet or collection of packets (e.g., IP packets transmitted over an IP network), an email message, an instant message (“IM”), a short message service (“SMS”) message, a multimedia messaging service (“MMS”) message, a chat, and/or combinations thereof. In some embodiments, the communication devices and/or computer systems may communicate over an audio and/or a video channel over the communication network 109.

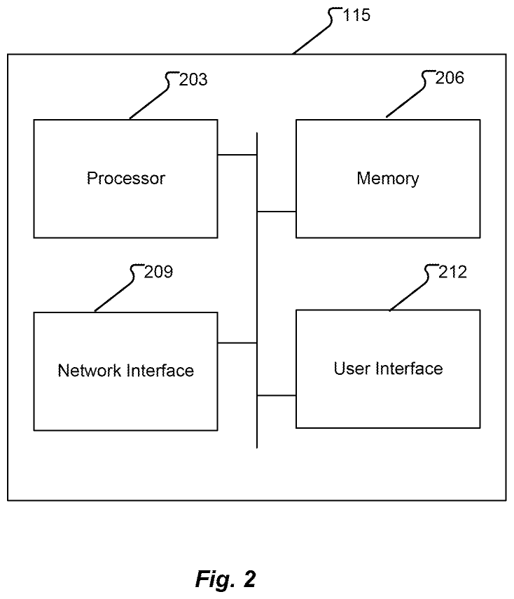

As illustrated in FIG. 2, the communication server 115 may include hardware and/or software resources that, among other things, provides the ability for controlling calls between users 103, 127 and/or automated agents executed by computer systems (e.g., via associated communication devices 106, computer systems 124, 127, etc.). Among other things, the communication server 115 may provide communication functionality that allows the communication devices and/or computer systems to hold party-to-party calls, multi-party calls, conference calls, and/or other collaborative communications over a same communication channel, in an established communication session. The communication server 115 may include a network interface 209, a processor 203, a user interface 212, and a memory 206. The memory 206 may comprise communication instructions, and/or the like.

The network interface 209 may provide the communication server 115 with the ability to send and receive communication packets or the like over the communication network 109 and/or the network 112. The network interface 209 may be provided as a network interface card (“NIC”), a network port, a modem, drivers for the same, and the like. Communications between the components of the communication server 115 and other devices connected to the communication network 109 or part of the network 112 may flow through the network interface of the communication server 115. In some embodiments, examples of a suitable network interface 209 include, without limitation, an antenna, a driver circuit, an Ethernet port, a modulator/demodulator, an NIC, an RJ-11 port, an RJ-45 port, an RS-232 port, a USB port, etc. The network interface 209 may include one or multiple different network interfaces depending upon whether the communication server 115 is connecting to a single communication network or multiple different types of communication networks. For instance, the communication server 115 may be provided with both a wired network interface and a wireless network interface without departing from the scope of the present disclosure. In some embodiments, the network interface 209 may include different communications ports that interconnect with various input/output lines.

In some embodiments, the processor 203 of the communication server 115 may correspond to one or more computer processing devices. For example, the processor 203 may be provided as silicon, an Application-Specific Integrated Circuit (“ASIC”), as a Field Programmable Gate Array (“FPGA”), any other type of Integrated Circuit (“IC”) chip, a collection of IC chips, and/or the like. In some embodiments, the processor 203 may be provided as a Central Processing Unit (“CPU”), a microprocessor, or a plurality of microprocessors that are configured to execute the instructions sets stored in memory. Upon executing the instruction sets stored in memory 206, the processor 203 enables various communications, compliance (e.g., authentication, checking, verification, and/or authorization, etc.), and/or interaction functions of the communication server 115, and may provide an ability to establish and maintain communication sessions between communication devices (e.g., communication device 106) and/or computer systems 121, 124 over the communication network 109 when specific predefined conditions are met.

The memory 206, or storage memory, may correspond to any type of non-transitory computer-readable medium. In some embodiments, the memory 206 may comprise volatile or non-volatile memory and a controller for the same. Non-limiting examples of the storage memory 206 that may be utilized in the communication server 115 may include Random Access Memory (“RAM”), Read Only Memory (“ROM”), buffer memory, flash memory, solid-state memory, or variants thereof. Any of these memory types may be considered non-transitory computer memory devices even though the data stored thereby can be changed one or more times. The memory 206 may be used to store information about communications, identifications, conditional requirements, times, authentication, authorization, compliance, history, and/or the like. In some embodiments, the memory 206 may be configured to store rules and/or the instruction sets depicted in addition to temporarily storing data for the processor 203 to execute various types of routines or functions. Although not depicted, the memory 206 may include instructions that enable the processor 203 to store data into a memory storage device 118 and retrieve information from the memory storage device 118. In some embodiments, the memory storage device 118 or the data stored therein may be stored internal to the communication server 115 (e.g., within the memory 203 of the communication server 115 rather than in a separate database) or in a separate server.

The communication instructions, when executed by the processor 203, may provide the ability for at least one of the communication devices (e.g., communication device 106) associated with a user (e.g., user 103) to establish one or more communication sessions that enable calls, messaging, holding or conducting communications, and/or otherwise sending and receiving messages via the communication session. In accordance with embodiments of the present disclosure the communication instructions may comprise instructions that, when executed by the processor 203, enable the communication server 115 to intercept BYE messages or other types of data sent via a PSTN so that BYE messages are not transmitted or propagated throughout the call center network until a determination is made that the ended call associated with the BYE message was ended intentionally. Instead, the BYE is responded to with positive acknowledgement without forwarding it to the internal side of the call center network. A new INVITE may then be initiated by a border element or other computing element towards the user 103 and the old, or original, internal leg may be patched with the new call towards user 103. The communication instructions may use existing private branch exchange (“PBX”) equipment, services, and/or infrastructure. The communication server 115 and the processor 203 executing the communication instructions may enable call routing, call authorization, and call termination. Examples of other functions performed via the communication instructions, when executed by the processor 203, include, but are in no way limited to, normalizing disparate networks, providing centralized routing of calls and management of user profiles, supporting converged voice and video bandwidth management, providing application sequencing capabilities, etc., and/or combinations thereof.

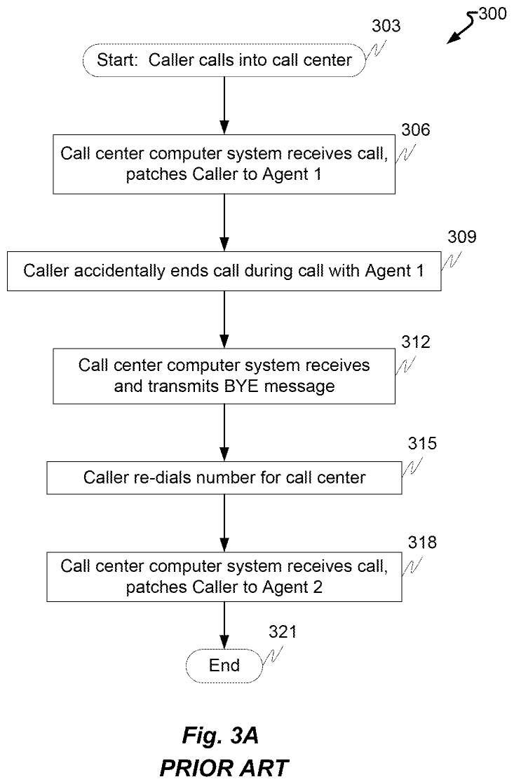

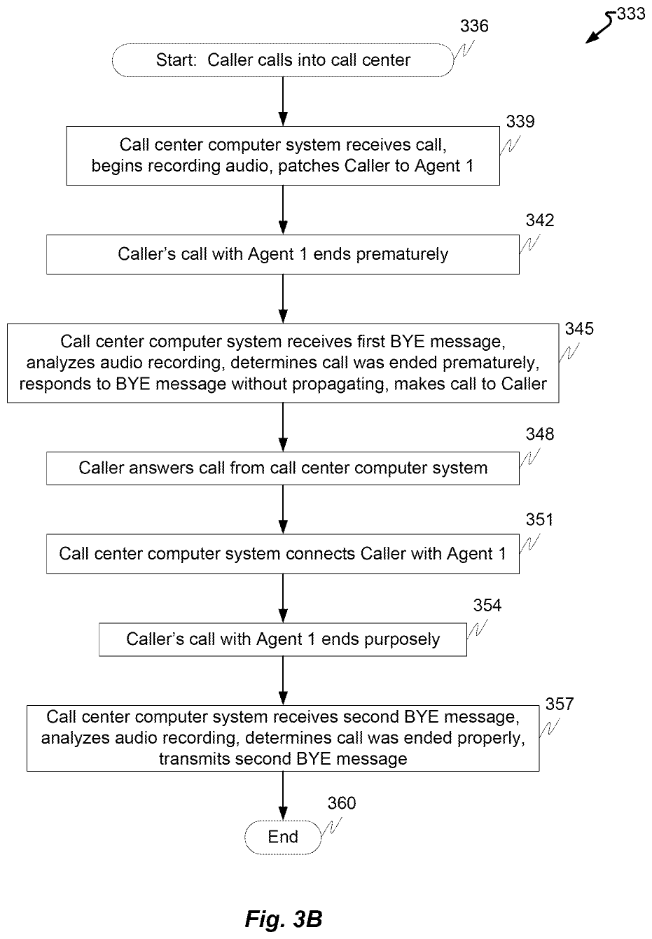

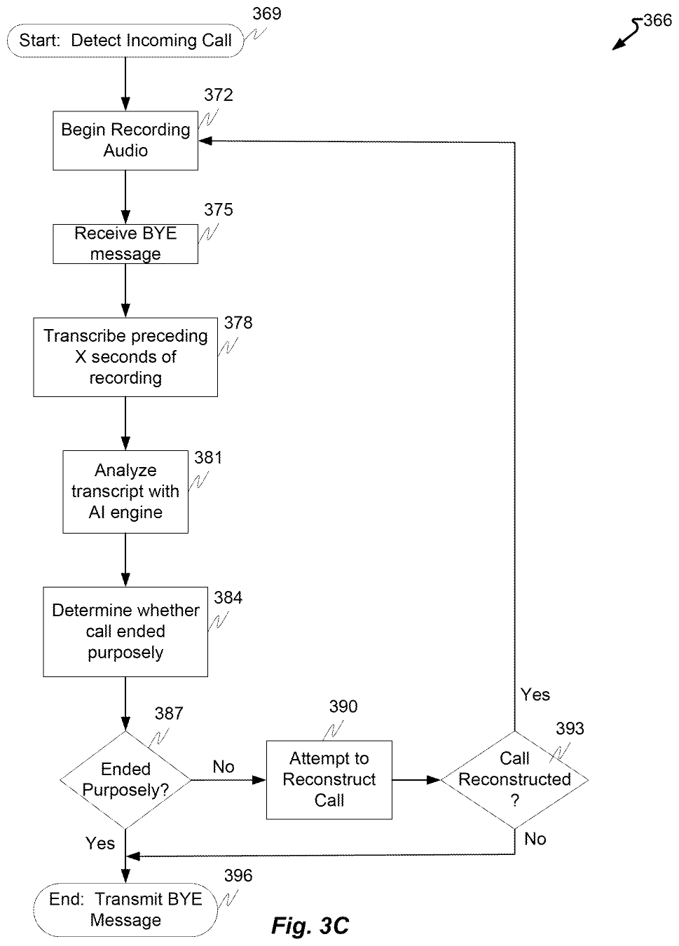

In some embodiments, the communication instructions may define rules and instructions for interactions between the communication server 115 and at least one of the communication devices (e.g., communication device 106) and computer systems (e.g., computer system 121, 124) in the communication system 100. The communication instructions may cause applications, web pages, pop-ups, and/or other digital interactions to be presented by the display of a computer system 121, 124. The communication instructions, when executed by the processor 203, may determine to present a user with one or more voice application pages, call options, request input, and/or provide other forms of output. These interactions may be provided by sending a message to a computer system 121, 124 over the network 112 in the communication system 100 causing a display device of the computer system 121, 124 to render information and user-selectable options. The communication instructions may be configured to perform at least some steps of the methods described in conjunction with FIGS. 3B and 3C and as otherwise described herein.

The user interface 212 may correspond to any type of input and/or output device, or combination thereof, that enables a user to interact with the communication server 115. As can be appreciated, the nature of the user interface 212 may depend upon the nature of the communication server 115. Examples of the user interface 212 may include, but are in no way limited to, user interface hardware and devices such as at least one touch-sensitive display elements, buttons, switches, keyboards, peripheral interface devices (e.g., mice, controller, joysticks, etc.) as described herein. It is an aspect of the present disclosure that one or more devices in the user interface 212 may provide an input that is interpreted by the processor 203 in controlling one or more components of the communication server 115.

The processor 203 may correspond to one or many computer processing devices. Non-limiting examples of a processor include a microprocessor, an IC chip, a General Processing Unit (“GPU”), a CPU, or the like. Examples of the processor 203 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, ARM® Cortex™-M processors, ARM® Cortex-A and ARIV1926EJS™ processors, other industry-equivalent processors, and may perform computational functions using any known or future-developed standard, instruction set, libraries, and/or architecture. The processor 203 may be a multipurpose, programmable device that accepts digital data as input, processes the digital data according to instructions stored in its internal memory, and provides results as output. The processor 203 may implement sequential digital logic as it has internal memory.

The network interface 209 may comprise hardware that facilitates communications with other devices (e.g., communication devices, computer systems, and/or servers, etc.) over the communication network 109 or the network 112. In some embodiments, the network interface 209 may include an Ethernet port, a Wireless Fidelity (“Wi-Fi”) card, an NIC, a cellular interface (e.g., antenna, filters, and associated circuitry), or the like. The network interface 209 may be configured to facilitate a connection between the communication device 106 and the communication server 115, and/or computer systems 121, 124, via the communication network 109 and/or network 112.

The memory 206 may correspond to any type of non-transitory computer-readable medium. In some embodiments, the memory 206 may comprise volatile or non-volatile memory and a controller for the same. Non-limiting examples of memory 206 that may be utilized in the communication server 115 may include RAM, ROM, buffer memory, flash memory, solid-state memory, and/or variants thereof. Any of these memory types may be considered non-transitory computer memory devices even though the data stored thereby can be changed one or more times. In some embodiments, the memory 206 may be configured to store rules and/or the instruction sets depicted in addition to temporarily storing data for the processor 203 to execute various types of routines or functions.

In some embodiments, the communication server 115 may comprise at least one display device that renders information, applications, windows, interactive elements, and/or other visual output via a user interface 212. The communication server 115 may further include at least one display controller that controls an operation of the display device. This operation may include the control of input (e.g., input provided by a user via the user interface 212, command input via the instruction sets in memory 206, and/or combinations thereof, etc.), output (e.g., display, rendered images, window behavior, etc.) and/or other functions of the display controller and display device.

As described above, the display device may comprise at least one display screen that selectively activates pixels and/or display elements to render one or more applications, windows, controls, interactive elements, icons, characters, images, etc. Examples of the display screen may include, but are in no way limited to, a Liquid Crystal Display (“LCD”), a Light Emitting Diode (“LED”) display, an Electroluminescent Display (“ELD”), an Organic LED (“OLED”) display, and/or some other type of display. In some embodiments, the display device may be configured to render information in one or more discrete areas (e.g., backgrounds, portions, windows, zones, etc.) of the display screen or superimposed in an area of the display screen.

FIG. 3A is a flow diagram depicting a conventional method 300 of establishing and maintaining a communication session. The method 300 begins at step 303 in which a first user makes a phone call. In the example illustrated in FIG. 3A, the first user is a caller making a call into a call center. It should be appreciated similar conventional methods of phone calls operate similarly. When the first user's phone call traverses the PSTN and reaches the call center, the call may be received by a border element such as a computer system controlled by the call center. The border element may operate to connect the phone call to one or more other computer systems such as proxy elements, switch elements, call center applications, etc. Call center applications may include, for example, one or more interactive voice response (IVR) systems. Call center applications may also include voice call applications using, for example, VoIP. For example, the first user's phone call may be directed to and received by an agent of the call center at 306.

Making a phone call may comprise the first user dialing a globalized E.164 number, such as +1 (555) 555-5555. The call may be made using, for example, an SIP phone or other SIP-enabled device. Dialing a number may invoke an INVITE message, such as an SIP INVITE message to be generated and transmitted toward the border element of the call center.

At 309, the phone call may end. For example, the first caller may unintentionally end the call either by accidentally pressing a call end button or due to a poor cellular service. When the call ends, a new message may be created, such as a BYE message. For example, an SIP message comprising an SIP BYE message may be generated and received by the border element. As illustrated in FIG. 3A, using a conventional system a BYE message is received by a border element and transmitted or distributed to computer systems and applications in the call center at 312. The BYE message is received by elements within the call center and is used to prompt the performance of post-call actions such as ending call recordings, updating call center agent workflows, etc.

Conventional BYE messages do not include a reason for the end of the call. As such, a BYE message generated as a result of a user accidentally hanging up the phone is the same as a BYE message generated as a result of a user intentionally hanging up the phone. As a result, when the first caller redials the number for the call center at 315, the call center treats the first caller as a new caller and the first caller must renavigate through a web of automated or IVR systems and may be connected with a different agent. At 318, when the first caller's second call is received by the call center, the call center patches the first caller through to a different agent than he or she was previously speaking with. As a result, time is wasted, the original call center agent's work fielding the first call is wasted, and the overall amount of time before the first caller's problem for which he or she is calling is higher than would be the amount of time had the first caller not unintentionally ended the first call. The conventional method 300 ends at 321.

As illustrated in FIG. 3B, an exemplary method 333 in accordance with embodiments described herein may be performed by one or more computer systems to reconnect callers in the event of an unintentionally terminated call. The method 333 may begin similar to the method 300 of FIG. 3A, described above, in which a first user makes a phone call. For example, the first user may make a call into a call center. When the first user's phone call traverses the PSTN and reaches the call center, the call may be received by a border element such as a computer system controlled by the call center. The border element may operate to connect the phone call to one or more other computer systems such as proxy elements, switch elements, call center applications, etc. Call center applications may include, for example, one or more interactive voice response (IVR) systems. Call center applications may also include voice call applications using, for example, VoIP. For example, the first user's phone call may be directed to and received by an agent of the call center at 339.

Making a phone call may comprise the first user dialing a globalized E.164 number, e.g., +1 (555) 555-5555. The call may be made using, for example, an SIP phone or other SIP-enabled device. Dialing a number may invoke an INVITE message, such as an SIP INVITE message to be generated and transmitted toward the border element of the call center.

At 342, the phone call may end. For example, the first caller may unintentionally end the call either by accidentally pressing a call end button or due to a poor cellular service. When the call ends, a new message may be created, such as a BYE message. For example, an SIP message comprising an SIP BYE message may be generated and received by the border element. As discussed above in relation to FIG. 3A, using a conventional system a BYE message is received by a border element and transmitted or distributed to computer systems and applications in the call center. With conventional methods, the BYE message is received by elements within the call center and is used to prompt the performance of post-call actions such as ending call recordings, updating call center agent workflows, etc. Using a method 333 as described herein, however, the BYE message may be received by the border element, or another computer system which may be configured to acknowledge the BYE message and determine whether the call ended intentionally or unintentionally. If the border element determines the call was ended unintentionally, the border element may, instead of propagating the BYE message through the call center, as in a conventional system, dial an outgoing call to the first caller at 345 in an attempt to reconnect with the caller. In this way, the BYE is not sent on the internal network side when it is established that the BYE does not mean an intentional call clearing request.

The new outgoing call from the border element may be received by the first caller who may answer the call at 348. If the first caller does not answer the call, the border element may receive a new BYE message, determine the new BYE message was received not as a result of an unintentionally ended call, but as a result of the first caller not answering, and the method may end with the border element transmitting the new BYE message throughout the internal network. In some embodiments, the border element may perform other post-call processes, such as noting in a call log that the call appeared to have been ended unintentionally, that an attempt was made to contact the first caller after the first call ended, and/or that the attempt to contact the first caller failed.

If the first caller answers the call at 348, the call center computer system, such as a border element, may connect the first caller with the agent, or other person, with whom the first caller was speaking originally at 351. In this way, the first caller and agent may continue speaking as if the original call had not ended.

Connecting the first caller with the agent or other person may comprise dialing a number associated with the agent or other person and patching the first caller together with the agent or other person. In the context of a call center, however, connecting the first caller with the agent or other person may comprise simply adding the first caller to an ongoing call with the agent or other person. For example, when a caller calls into a call center and is connected with an agent, a communication session may be established through which the caller and the agent may communicate. With conventional methods of managing BYE messages such as discussed above in relation to FIG. 3A, when the caller hangs up and a BYE message is received by the call center, the BYE message triggers the end of the communication session. Using a method as described herein, the BYE message may instead be intercepted by the border element which may be configured to determine the call was ended unintentionally and, in response to determining the call ended unintentionally, attempt to re-call the caller so that the communication session may continue. When the border element determines the call was ended unintentionally and calls the first caller with a new call, the border element can add the new call to the communication session with the agent. From the agent's point of view, it may appear as if nothing had changed.

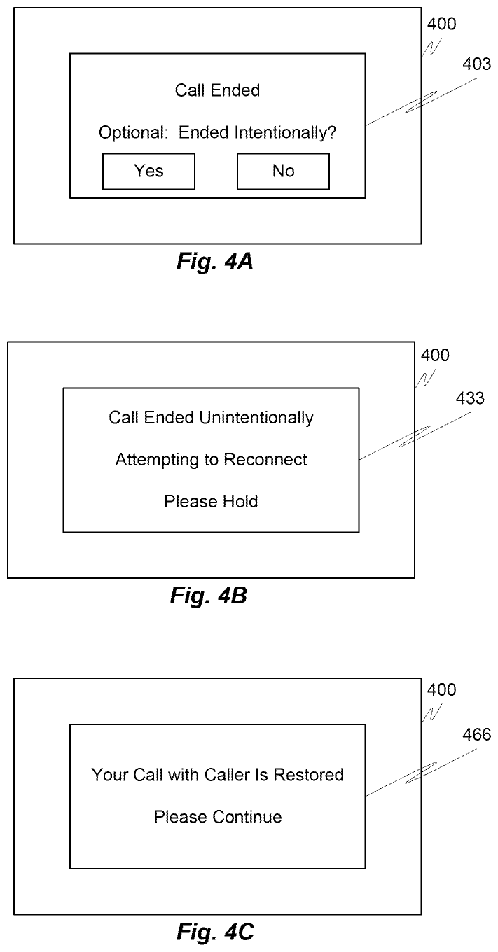

In some embodiments, a call center agent speaking with a caller may be presented with a notification indicating that the call was dropped and may inform the call center agent as to the current status. For example, during a communication session with a caller, the call center agent may participate in the communication session using a device such as a computer system. The computer system may include a display device displaying a user interface. The user interface may present information relating to the communication session, such as descriptions of the caller. When a call ends, the user interface may display a notification informing the agent that the call was dropped and that the border element is determining whether the call was dropped unintentionally. Such a user interface may be as described below in relation to FIGS. 4A-C.

At 354, the reconnected call ends purposely, for example the caller and agent may exchange goodbyes and hang up the phone, and at 357, the call center computer system may receive a new BYE message in response to the second call ending. In response to receiving the new BYE message, the call center computer system, such as the border element, may again process audio associated with the call to determine whether the second call was ended intentionally or unintentionally. If the computer system determines the call was ended unintentionally, the method 333 may return to step 345 in which another attempt may be made to contact the first caller. If, on the other hand, the computer system determines the call was ended intentionally, the method may comprise the computer system transmitting the original BYE message to one or more other computing systems and/or processes.

After the BYE message is transmitted, the method 333 may end. The method of receiving a BYE message and making the determination as to whether the call ended intentionally or unintentionally, which may be performed by a call center computer system or border element may be as described in greater detail below in relation to FIG. 3C.

As discussed above, conventional BYE messages do not include a reason for the end of the call. As such, a BYE message generated as a result of a user accidentally hanging up the phone is the same as a BYE message generated as a result of a user intentionally hanging up the phone. Using a method as described herein, a BYE message received by a call center which was generated as a result of a user accidentally hanging up the phone may be acknowledged by a computing element such as a border element without alerting any other element within the call center network. The border element or other computing element may, upon determining the call was ended unintentionally, attempt to reconnect the caller by re-dialing the caller. Only when a call is ended intentionally, or in the case of the computing element's attempt to reconnect the caller failing, is a BYE message distributed throughout the call center network.

As illustrated in FIG. 3C, a method 366 of reconstructing calls may be performed by a computer system such as a border element of a contact center. The method 366 may begin when an incoming call is detected by the computer system at 369. Detecting an incoming call may comprise, for example, receiving an INVITE message via a PSTN. In response to the incoming call, the computer system and other computer systems within a network of the contact center may perform one or more call initialization processes. For example, a communication session may be established connecting the caller with one or more automated response bots or a human agent.

The computer system, or another computer system in communication with the computer system, may also begin recording audio of the incoming call or the communication session at 372. In some embodiments, as described below, a transcription of the audio may be made. It should be appreciated that a complete audio recording of the call may not be necessary and that in some embodiments only portions of the call may be recorded.

When the call ends, a BYE message may be received by the computer system at 375. The BYE message may be received for example by the computer system from a PSNT provider or a SIP server.

Upon receiving a BYE message, the computer system may store the BYE message in memory. In some embodiments, the BYE message may be stored in memory along with an identifier or metadata indicating with which communication session or call the BYE message is associated.

After receiving the BYE message, all or a portion of the audio recording created for the call may be transcribed by the computer system or by another computer system 378. It should be appreciated that in some embodiments, transcription service may be performed in real-time, and the transcription may take place during the call. For example, during a call, the processing discussed below in relation to step 381 may be performed, regardless of whether a BYE message has been received. It should be appreciated it is not necessary that the call be transcribed only upon ending. The transcription may be done in parallel throughout the call. During the call, the transcription may be used to determine, in real-time, whether the caller and/or agent has intentionally decided to hang up or not. In this way, as soon as a BYE message is received, the service can determine immediately whether the BYE message is consistent with the actual state of the conversation and thus the call was ended intentionally or whether the BYE message is inconsistent with the state of the conversation and thus the call was ended unintentionally.

At 381, the transcription of all or a portion of the audio recording may be processed and analyzed by an artificial intelligence (AI) engine. The AI engine may be trained using machine learning (ML) to determine, based on a transcription of audio of a phone call, whether the phone ended unintentionally. For example, if a transcription of a call includes the words “goodbye” at the end, the call can be assumed to have not ended unintentionally and instead to have ended intentionally. If, on the other hand, the transcription of the call ends with users discussing a topic and/or in the middle of a sentence, the call can be assumed to have ended unintentionally and not to have ended intentionally.

Training the AI engine may involve inputting transcriptions of known calls into an ML system. The ML system may build an AI engine configured to accept a transcription of a call as an input and to output an indicator as to whether the call ended intentionally or unintentionally. In some embodiments, the indicator as to whether the call ended intentionally or unintentionally may comprise a percentage or other type of score indicating a likelihood of the call having ended intentionally or unintentionally.

In some embodiments, an AI engine may be trained through the use of active feedback received from participants in a call. For example, call center agents may be enabled to review past calls, indicating whether the calls were ended intentionally or unintentionally. Similarly, callers calling into a call center may, after ending the call, receive a text message asking about the quality of the call and whether the call was ended intentionally or unintentionally. In this way, a training database of call logs may be built and used to train an AI engine using ML.

By using a natural language processing (NLP) or natural language understanding (NLU) system or a similar technology, the computer system may be configured to determine whether, based on audio of the call, the call was dropped or otherwise accidentally ended, or whether the call was ended intentionally. It should be appreciated that in some embodiments, such NLP may be performed through processing audio directly and thus no transcription of the call may be required.

As discussed above, the NLP or NLU system may process audio of a call during the call in real time or audio of a recording of a call for a preceding amount of time leading up to receiving a BYE message.

At 384, the computer system may determine whether the call ended intentionally. Determining whether a call ended intentionally may comprise receiving an indicator from an AI engine or other computer system as to whether the call ended intentionally. In some embodiments, determining whether a call ended intentionally may comprise receiving a percentage or score from an AI engine or other computer system as to a likelihood whether the call ended intentionally or unintentionally and may comprise determining, based on the likelihood of whether the call ended intentionally or unintentionally, whether the call ended intentionally. For example, determining whether a call ended intentionally may comprise comparing a percentage or score indicating a likelihood of the call having ended intentionally or unintentionally received from an AI engine to a threshold score or percentage.

At 387, if the call ended intentionally, the method 366 may end at 396 in which the BYE message is transmitted. As discussed above, in some embodiments, the computer system may perform other post-call processes, such as noting in a call log that the call appeared to have been ended intentionally.

If, at 387, the computer system determines the call was not ended intentionally, the method 366 may proceed with the computer system attempting to reconstruct the call at 390. Reconstructing the call may comprise, in some embodiments, automatically calling one or more people participating in the call. It should be appreciated that in some embodiments, a call may be reconstructed without one or more of the users participating in the call noticing. For example, consider a person calling into a call center, speaking with an agent, being placed on hold, and then accidentally hanging up or losing connection. The person may then receive a call from the call center and when he or she answers, he or she will be placed back on hold waiting for the agent. In such a scenario, the agent may not receive any notification or indication that the person ever lost connection or hung up. Instead, the agent may take the person off hold and continue the call as if the person never lost connection or hung up.

If, at 393, the call was reconstructed, the method 366 may return to 372 in which audio from the reconstructed call may begin to be recorded and the method 366 may continue on as discussed above with the reconstructed call. If, on the other hand, the call was not reconstructed, for example if the caller did not answer when the computer system called the caller attempting to reconnect, the method 366 may proceed to the end at 309 in which the BYE message is transmitted. As discussed above, in some embodiments, the computer system may perform other post-call processes, such as noting in a call log that the call appeared to have been ended unintentionally, that an attempt was made to contact the first caller after the first call ended, and/or that the attempt to contact the first caller failed.

In some embodiments, when a call is being made towards a dropped caller, an announcement may be made to a call center agent, such as an audible announcement, or a visual announcement in a user interface, that the caller is being reconnected or that an attempt to reconnect with the colors being made. In this way, the call center agent may know not to hang up the phone if the caller appears to be taking too much time to respond.

In some embodiments, following a dropped call, a message may be sent to the caller asking the caller to either accept an incoming call from the call center if he or she wishes to continue the conversation with the agent, or to offer a number to the caller such that the caller may call back and be reconnected with the same agent without losing the conversation context by being connected with a different agent. It should be appreciated that the number sent to the caller may be the same number as the general number for the call center. The call center may be configured to determine an incoming call is coming from the caller and to, based on the determination that the incoming call is from the caller, reconnect the caller with the original call center agent.

If the call was reconstructed at 393, and the reconstructed call ends intentionally, the computer system may transmit the original BYE message and/or a new BYE message as received following the ending of the reconstructed call, note in a call log that the call appeared to have originally been ended unintentionally, that an attempt was made to contact the first caller after the first call ended, and/or that the attempt to contact the first caller succeeded, and that the call eventually ended intentionally.

Transmitting the BYE message may comprise sharing the BYE message with one or more computer systems, applications, processes, etc., throughout, for example, a call center network. Such applications and processes may include, for example, call recording applications or call monitoring applications.

As discussed above, conventional BYE messages do not include a reason for the end of the call. As such, a BYE message generated as a result of a user accidentally hanging up the phone is the same as a BYE message generated as a result of a user intentionally hanging up the phone. Using a method as described herein, a BYE message generated as a result of a user accidentally hanging up the phone may not be transmitted throughout a call center network. Instead, an attempt may be made to reconnect the user with the call center agent so that the call may be completed.

It should be appreciated the above methods may be implemented in conjunction with applications in addition to call centers and/or PSTN phone calls. For example, a conference call application may be configured to implement the same or a similar method as that of method 366 discussed above. For example, if a caller is participating in a group call or a conference call and the caller accidentally hangs up, loses connection, or otherwise is dropped from the call, the caller may receive a callback from a conference call hosting system. The callback may be received in response to the conference call hosting system determining the caller did not intentionally end the call. Upon answering the callback, the caller may be placed back into the conference call without being required to reenter meeting information or password details.

In some embodiments, a caller participating in a conference call who hangs up or is otherwise disconnected may not receive a callback unless the conference call hosting system determines the caller was an active speaker during the conference call. For example, if, based on analysis of the transcription, the conference call hosting system determines the caller's call was dropped while the caller was speaking, just finished speaking, or was mentioned, and determines the caller did not intentionally end the call, the conference call hosting system may determine the caller should receive a callback. Such an embodiment may be useful in certain circumstances such as when a user accidentally presses an “end call” button as opposed to an “unmute” button.

As another example, consider a caller calling into a call center and being placed on hold. For example, call centers for corporations such as airlines often require excessive hold times to reach a human. Using a system or method as described herein, if a caller accidentally hangs up or the call is dropped while the caller is on hold, whether he or she has spoken with a human yet or not, the caller can be enabled to receive a call back. If the caller receives and answers the call back, the caller can be placed back on hold in the same position that he or she was in prior to ending the first call.

As illustrated in FIGS. 4A-4C, a call center agent speaking with a caller may be presented with a notification indicating that the call was dropped and may inform the call center agent as to the current status. For example, during a communication session with a caller, the call center agent may participate in the communication session using a device such as a computer system. The computer system may include a display device displaying a user interface. The user interface may present information relating to the communication session, such as descriptions of the caller. When a call ends, the user interface may display a notification informing the agent that the call was dropped and that the border element is determining whether the call was dropped unintentionally.

As illustrated in FIG. 4A, a user interface 400 may be displayed on a user device of an agent of a call center participating in a communication session with a caller. The caller may have begun a call with the call center for example by dialing a number using a PSTN provider. While speaking with the agent over the call, the caller may unintentionally end the call, or the call may have otherwise ended unintentionally. The user interface 400 may display a notification 403 indicating the call was ended. It should be appreciated that the end of the call may not mean the communication session also ended. The communication session may continue until it is determined whether the call ended intentionally on behalf of one or more of the parties to the call. In some embodiments, and as illustrated in FIG. 4A, the agent may be presented with an opportunity to note whether the call was ended intentionally. Such feedback from the agent may be used to train an AI engine as described herein. Regardless of whether feedback is received from the agent, a computer system such as a border element may process audio of the call to determine whether the call ended intentionally as described herein. For example, if no response is received from the agent, the border element may independently determine whether the call was ended intentionally or unintentionally.

As illustrated in FIG. 4B, when it is determined that a call was ended unintentionally, the call agent user device may display a notification 433 indicating the call was ended unintentionally and that an attempt is being made to reconnect the caller.

As illustrated in FIG. 4C, if the attempt to reconnect the caller is successful, a notification 466 may be displayed on the call center user device indicating the attempt was successful and informing the agent he or she may continue with the call. If, on the other hand, the attempt to reconnect was unsuccessful, a notification may be displayed to inform the agent.

It should be appreciated the above-discussed user interface notifications may be an optional element of the systems and methods described herein. In practice, it may be possible to reconnect a caller with an agent without alerting the agent to the fact that the call was ever ended.

While the above methods and systems describe the functions performed by a border element of a call center, it should be appreciated the same or similar methods and systems may be implemented by other computer systems. For example, a call center agent computer system may be configured detect an end of a call, determine the reason for the end of the call, and attempt to reconstruct an unintentionally ended call. Similarly, the functions of the border element described herein may be performed by an element within the PSTN itself, such that the border element does not receive a BYE message until the reason for the call end has been determined and a reconstruction of the call has been attempted.

Any of the steps, functions, and operations discussed herein can be performed continuously and automatically.

The exemplary systems and methods of this disclosure have been described in relation to communication devices, multiple-device access environments, and communication systems. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein. For instance, while described in conjunction with client-server networks (e.g., conferencing servers, client devices, etc.), it should be appreciated that the components, systems, and/or methods described herein may be employed as part of a peer-to-peer network or other network. As can be appreciated, in a peer-to-peer network, the various components or systems described in conjunction with the communication system 100 may be part of one or more endpoints, or computers, participating in the peer-to-peer network.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments of the present disclosure include a communication method comprising detecting a call ended; analyzing data associated with the call; determining, based on the data, the call ended unintentionally; and reconstructing the call based on the determination the call ended unintentionally.

Aspects of the above method include wherein detecting the call ended comprises receiving a BYE message. Aspects of the above method include wherein the BYE message is received by a border element. Aspects of the above method include wherein in response to determining the call ended unintentionally, the BYE message is not propagated through an internal network. Aspects of the above method include wherein reconstructing the call comprises calling a caller associated with the call. Aspects of the above method include wherein the call is reconstructed without informing at least one party participating in the call. Aspects of the above method include wherein analyzing data associated with the call comprises processing a transcript of the call using an artificial intelligence system. Aspects of the above method include wherein the artificial intelligence system is trained to identify whether a conversation ended intentionally or unintentionally. Aspects of the above method include the method further comprising in response to determining the call ended unintentionally, intercepting a BYE message received from a PSTN; after reconstructing the call, determining the reconstructed call ended intentionally; and based on determining the reconstructed call ended intentionally, transmitting the BYE message. Aspects of the above method include wherein determining the reconstructed call ended intentionally comprises determining the call ended due to a caller purposely ending the call. Aspects of the above method include wherein determining the reconstructed call ended unintentionally comprises determining the call was dropped.

Embodiments of the present disclosure include a computer system comprising: a processor; and a computer-readable storage medium storing computer-readable instructions which, when executed by the processor, cause the processor to execute a method, the method comprising: detecting a call ended; analyzing data associated with the call; determining, based on the data, the call ended unintentionally; and reconstructing the call based on the determination the call ended unintentionally.

Aspects of the above computer system include wherein detecting the call ended comprises receiving a BYE message. Aspects of the above computer system include wherein the BYE message is received by a border element. Aspects of the above computer system include in response to determining the call ended unintentionally, the BYE message is not propagated through an internal network. Aspects of the above computer system include wherein reconstructing the call comprises calling a caller associated with the call. Aspects of the above computer system include wherein the call is reconstructed without informing at least one party participating in the call. Aspects of the above computer system include wherein analyzing data associated with the call comprises processing a transcript of the call using an artificial intelligence system. Aspects of the above computer system include wherein the artificial intelligence system is trained to identify whether a conversation ended intentionally or unintentionally. Aspects of the above computer system include the method further comprising in response to determining the call ended unintentionally, intercepting a BYE message received from a PSTN; after reconstructing the call, determining the reconstructed call ended intentionally; and based on determining the reconstructed call ended intentionally, transmitting the BYE message. Aspects of the above computer system include wherein determining the reconstructed call ended intentionally comprises determining the call ended due to a caller purposely ending the call. Aspects of the above computer system include wherein determining the reconstructed call ended unintentionally comprises determining the call was dropped.

Embodiments of the present disclosure include a computer program product comprising: a non-transitory computer-readable storage medium having computer-readable program code embodied therewith, the computer-readable program code configured, when executed by a processor, to execute a method, the method comprising: detecting a call ended; analyzing data associated with the call; determining, based on the data, the call ended unintentionally; and reconstructing the call based on the determination the call ended unintentionally.

Aspects of the above computer program product include wherein detecting the call ended comprises receiving a BYE message. Aspects of the above computer program product include wherein the BYE message is received by a border element. Aspects of the above computer program product include wherein in response to determining the call ended unintentionally, the BYE message is not propagated through an internal network. Aspects of the above computer program product include wherein reconstructing the call comprises calling a caller associated with the call. Aspects of the above computer program product include wherein the call is reconstructed without informing at least one party participating in the call. Aspects of the above computer program product include wherein analyzing data associated with the call comprises processing a transcript of the call using an artificial intelligence system. Aspects of the above computer program product include wherein the artificial intelligence system is trained to identify whether a conversation ended intentionally or unintentionally. Aspects of the above computer program product include the method further comprising in response to determining the call ended unintentionally, intercepting a BYE message received from a PSTN; after reconstructing the call, determining the reconstructed call ended intentionally; and based on determining the reconstructed call ended intentionally, transmitting the BYE message. Aspects of the above computer program product include wherein determining the reconstructed call ended intentionally comprises determining the call ended due to a caller purposely ending the call. Aspects of the above computer program product include wherein determining the reconstructed call ended unintentionally comprises determining the call was dropped.

Any one or more of the aspects/embodiments as substantially disclosed herein. Any one or more of the aspects/embodiments as substantially disclosed herein optionally in combination with any one or more other aspects/embodiments as substantially disclosed herein. One or means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate,” “compute,” and variations thereof, as used herein, are used interchangeably, and include any type of methodology, process, mathematical operation, or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Methods described or claimed herein can be performed with traditional executable instruction sets that are finite and operate on a fixed set of inputs to provide one or more defined outputs. Alternatively, or additionally, methods described or claimed herein can be performed using AI, machine learning, neural networks, or the like. In other words, a system or server is contemplated to include finite instruction sets and/or artificial intelligence-based models/neural networks to perform some or all of the steps described herein.

What is claimed is:

1. A communication method comprising:
detecting a call ended;
analyzing data associated with the call;
determining, based on the data, the call ended unintentionally; and
reconstructing the call based on the determination the call ended unintentionally.

2. The method of claim 1, wherein detecting the call ended comprises receiving a BYE message.

3. The method of claim 2, wherein the BYE message is received by a border element.

4. The method of claim 2, wherein, in response to determining the call ended unintentionally, the BYE message is not propagated through an internal network.

5. The method of claim 1, wherein reconstructing the call comprises calling a caller associated with the call.

6. The method of claim 5, wherein the call is reconstructed without informing at least one party participating in the call.

7. The method of claim 1, wherein analyzing data associated with the call comprises processing a transcript of the call using an artificial intelligence system.

8. The method of claim 7, wherein the artificial intelligence system is trained to identify whether a conversation ended intentionally or unintentionally.

9. The method of claim 1, further comprising:
in response to determining the call ended unintentionally, intercepting a BYE message received from a PSTN;
after reconstructing the call, determining the reconstructed call ended intentionally; and
based on determining the reconstructed call ended intentionally, transmitting the BYE message.

10. The method of claim 9, wherein determining the reconstructed call ended intentionally comprises determining the call ended due to a caller purposely ending the call.

11. The method of claim 1, wherein determining the reconstructed call ended unintentionally comprises determining the call was dropped.

12. A computer system comprising:
a processor; and
a computer-readable storage medium storing computer-readable instructions which, when executed by the processor, cause the processor to execute a method, the method comprising:
detecting a call ended;
analyzing data associated with the call;
determining, based on the data, the call ended unintentionally; and
reconstructing the call based on the determination the call ended unintentionally.

13. The computer system of claim 12, wherein detecting the call ended comprises receiving a BYE message.

14. The computer system of claim 13, wherein the BYE message is received by a border element.

15. The computer system of claim 13, wherein, in response to determining the call ended unintentionally, the BYE message is not propagated through an internal network.

16. The computer system of claim 12, wherein reconstructing the call comprises calling a caller associated with the call.

17. A computer program product comprising:
a non-transitory computer-readable storage medium having computer-readable program code embodied therewith, the computer-readable program code configured, when executed by a processor, to execute a method, the method comprising:
detecting a call ended;
analyzing data associated with the call;
determining, based on the data, the call ended unintentionally; and
reconstructing the call based on the determination the call ended unintentionally.

18. The computer program product of claim 17, wherein detecting the call ended comprises receiving a BYE message.

19. The computer program product of claim 18, wherein the BYE message is received by a border element.

20. The computer program product of claim 18, wherein, in response to determining the call ended unintentionally, the BYE message is not propagated through an internal network.
